(19) United States
(12) Patent Application Publication
(10) Pub. No.: US 2013/0220510 A1
(43) Pub. Date: Aug. 29, 2013

(54) PRESSURE-SENSITIVE ADHESIVE PRODUCT

(71) Applicant: NITTO DENKO CORPORATION, (US)

(72) Inventors: Shuuhei YAMAMOTO, Osaka (JP); Hironori TAMAI, Osaka (JP)

(73) Assignee: NITTO DENKO CORPORATION, Osaka (JP)

(21) Appl. No.: 13/778,340

(22) Filed: Feb. 27, 2013

(30) Foreign Application Priority Data
Feb. 29, 2012 (JP) 2012-043870

(51) Int. Cl. B32B 37/14; C09J 7/02

(52) U.S. Cl. CPC B32B 37/144; C09J 7/0207
USPC 156/60; 428/343

(57) ABSTRACT

The present invention relates to a pressure-sensitive adhesive product including a substrate and at least two point-like pressure-sensitive adhesives on the substrate, wherein an area ratio is from 10 to 60%. The area ratio (%) is a proportion of an area occupied by said point-like pressure-sensitive adhesives per unit area of the substrate. The pressure-sensitive adhesive product is excellent in re-peelability. In addition, the present invention also relates to a fixation method of components, including transferring the point-like pressure-sensitive adhesives in the pressure-sensitive adhesive product to a first component, and then fixing the first component to a second component.

The present invention relates to a pressure-sensitive adhesive product. More particularly, the invention relates to a pressure-sensitive adhesive product having excellent re-peelability.

### BACKGROUND OF THE INVENTION

A pressure-sensitive adhesive product has been conventionally used in various fields. In the pressure-sensitive adhesive product, there is a case where air is trapped between a pressure-sensitive adhesive part and an adherend when the pressure-sensitive adhesive product is attached to the adherend, whereby lifting and peeling of the pressure-sensitive adhesive product or wrinkles in the pressure-sensitive adhesive product may arise due to air bubbles, leading to a problem in appearance of the pressure-sensitive adhesive product or the attaching property of the pressure-sensitive adhesive product to an adherend. Against such problem, there has been proposed a pressure-sensitive adhesive product having two or more point-like pressure-sensitive adhesives on a substrate, i.e., having a so-called dot-pattern pressure-sensitive adhesive surface.

For example, a pressure-sensitive adhesive product in which a dot diameter of a pressure-sensitive adhesive is less than 1.5 mm, a thickness of the pressure-sensitive adhesive is less than 25 μm, an area ratio is set to 0.7 or more, and necessary and sufficient pressure-sensitive adhesive force is secured has been known as a pressure-sensitive adhesive product having a dot-pattern pressure-sensitive adhesive surface (see, Patent Document 1).
Patent Document 1: JP-A-2010-174148

However, the above-mentioned pressure-sensitive adhesive product has a strong pressure-sensitive adhesive force and cannot be easily peeled from an adherend after being attached to an adherend. Furthermore, when the pressure-sensitive adhesive product is peeled from the adherend, a damage may occur in the adherend. Thus, it is difficult to use the pressure-sensitive adhesive product in a use application requiring re-peelability.

### SUMMARY OF THE IVENTION

Accordingly, an object of the present invention is to provide a pressure-sensitive adhesive product including two or more point-like pressure-sensitive adhesives on a substrate and having an excellent re-peelability.

The present inventors have assiduously studied for the purpose of attaining the above object and, as a result, have found that good re-peelability is obtained when an area ratio of a pressure-sensitive adhesive product including two or more point-like pressure-sensitive adhesives on a substrate is set to fall within a given range. The inventors have further made studies on the basis of this finding, and have completed the present invention.

Namely, the present invention provides a pressure-sensitive adhesive product comprising a substrate and at least two point-like pressure-sensitive adhesives on the substrate, wherein an area ratio defined below is from 10 to 60%;

area ratio (%): a proportion of an area occupied by the point-like pressure-sensitive adhesives per unit area of the substrate.

In the above-mentioned pressure-sensitive adhesive product, it is preferable that an interval between adjacent two of the point-like pressure-sensitive adhesives is 0.5 mm or more and less than 4.0 mm.

Furthermore, the present invention provides a fixation method of components, comprising transferring the point-like pressure-sensitive adhesives in the above-mentioned pressure-sensitive adhesive product to a first component, and then fixing the first component to a second component.

According to the pressure-sensitive adhesive product of the present invention, two or more point-like pressure-sensitive adhesives are present on a substrate and an area ratio falls with a given range. Therefore, the pressure-sensitive adhesive product has an excellent re-peelability.

### BRIEF DESCRIPTION OF THE DRAWINGS

FIG. 1 is an outline top view showing one embodiment of a pressure-sensitive adhesive product of the present invention.

FIG. 2 is an outline cross-sectional view showing a cross-sectional view taken along II-II″ line of the pressure-sensitive adhesive product shown in FIG. 1.

FIG. 3 is an enlarged top view of the pressure-sensitive adhesive product shown in FIG. 1.

FIG. 4 is an explanatory view (perspective view) showing the positional relationship of a polycarbonate plate, a test piece and a weight in a constant-load peel test.

FIG. 5 is an explanatory view (side view) showing the positional relationship of a polycarbonate plate, a test piece and a weight in a constant-load peel test.

FIG. 6 is an outline view (cross-sectional view) showing one embodiment of a fixation method with a pressure-sensitive adhesive product of the present invention.

### DETAILED DESCRIPTION OF THE INVENTION

The pressure-sensitive adhesive product of the present invention is a pressure-sensitive adhesive product including two or more point-like pressure-sensitive adhesives on a substrate and having an area ratio (area ratio (%): proportion of an area occupied by the point-like pressure-sensitive adhesives per unit area of the substrate) of from 10 to 60%. The pressure-sensitive adhesive product of the present invention is produced by forming two or more point-like pressure-sensitive adhesives on a substrate using a pressure-sensitive adhesive composition. The pressure-sensitive adhesive product of the present invention can transfer the point-like pressure-sensitive adhesives to an adherend by being attached to the adherend. In the present description, the area ratio defined above is sometimes simply referred to as an “area ratio”. In the present description, the term “pressure-sensitive adhesive product” means a product having a pressure-sensitive adhesive part provided by a pressure-sensitive adhesive. Although not particularly limited, the pressure-sensitive adhesive product includes a pressure-sensitive adhesive tape, a pressure-sensitive adhesive sheet, a pressure-sensitive adhesive label, a laminate of those, and a winding product of those.

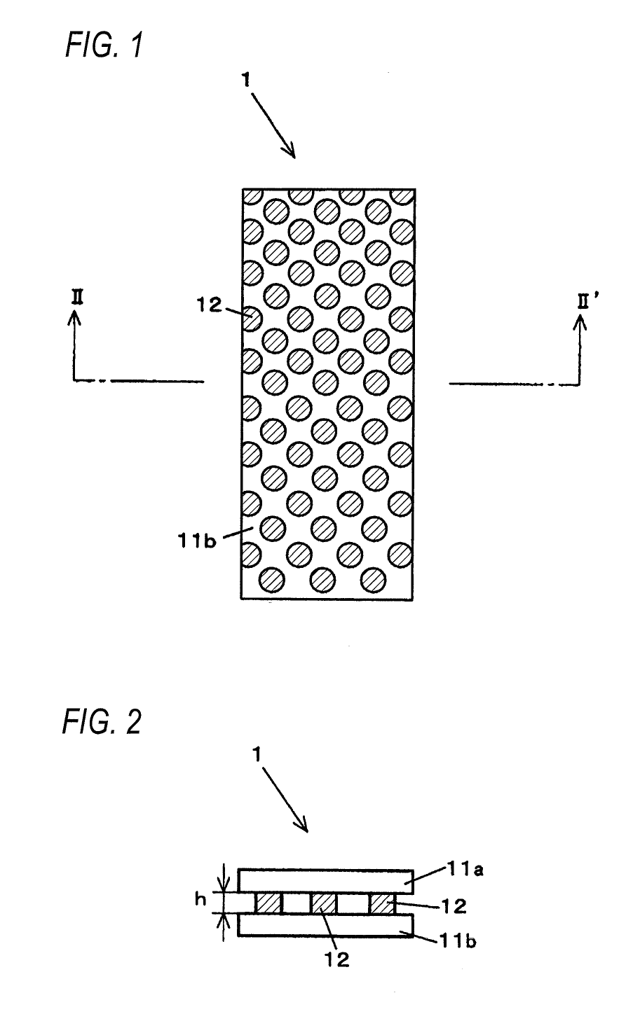

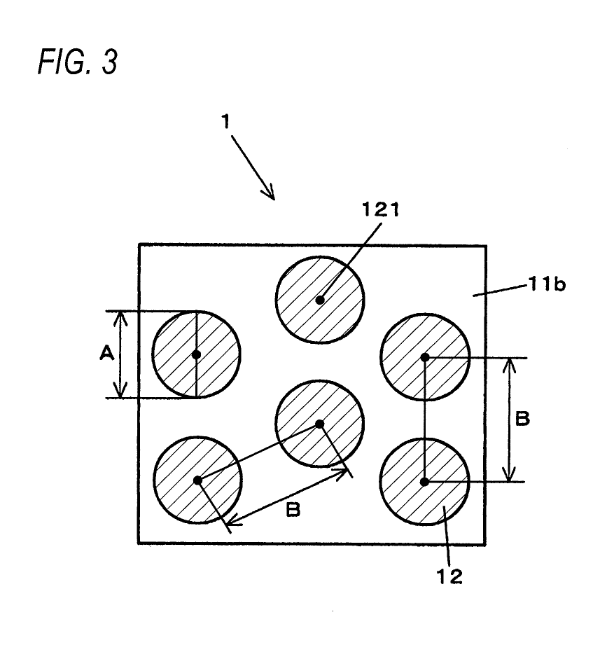

The pressure-sensitive adhesive product of the present invention may be a pressure-sensitive adhesive product having two or more point-like pressure-sensitive adhesives on one substrate (single separator type) or may be a pressure-sensitive adhesive product having two or more point-like pressure-sensitive adhesives between two substrate (double separator type). In other words, in the pressure-sensitive adhesive product of the present invention, faces provided by the point-like pressure-sensitive adhesives (pressure-sensitive adhesive faces) may be respectively protected by separate substrates, or may be protected by one substrate in a form of being wound in a roll shape. For example, the pressure-sensitive adhesive product shown in FIGS. 1, 2 and 3 is a double separator type. In FIGS. 1 and 3, the indication of a substrate 11a is omitted.

The point-like pressure-sensitive adhesives (which may also be referred as “dot-form (dot-like) pressure-sensitive adhesives” etc.) may be regularly present on the substrate or may be irregularly present thereon. It is preferred in the pressure-sensitive adhesive product of the present invention that the point-like pressure-sensitive adhesives are regularly present on the substrate from the point of stably obtaining characteristics such as re-peelability and adhesiveness. Specific example of the pressure-sensitive adhesive product in which point-like pressure-sensitive adhesives are regularly present on a substrate includes the pressure-sensitive adhesive product shown in FIGS. 1, 2 and 3.

The area ratio of the pressure-sensitive adhesive product of the present invention is from 10 to 60%, preferably from 12 to 57%, and more preferably from 15 to 55%. Since the pressure-sensitive adhesive product of the present invention has an area ratio of 10% or more, it is possible to obtain sufficient adhesive force to an adherend. Furthermore, since the pressure-sensitive adhesive product of the present invention has an area ratio of 60% or less, the pressure-sensitive adhesive product is excellent in re-peelability. In the present description, the term “re-peelablity” means such a property that when the pressure-sensitive adhesive product attached to an adherend is peeled from the adherend, the pressure-sensitive adhesive product can be easily peeled from the adherend by hand, and also means such a property that after attaching a component to which point-like pressure-sensitive adhesives of the pressure-sensitive adhesive product have been transferred (point-like pressure-sensitive adhesive-attached component) to an adherend (for example, a chassis or other components), the point-like pressure-sensitive adhesive-attached component can be easily peeled from the adherend by hand.

The above-mentioned area ratio is defined as follows.

Area ratio (%): Proportion of area occupied by point-like pressure-sensitive adhesives per unit area of substrate

The above-mentioned area ratio, an interval between point-like pressure-sensitive adhesives described below, a shape of the point-like pressure-sensitive adhesive described below, and a size of the point-like pressure-sensitive adhesive described below in the pressure-sensitive adhesive product can be obtained by, for example, observing and actually measuring the point-like pressure-sensitive adhesives on the pressure-sensitive adhesive product with a microscope (apparatus name “VHX-1000”, manufactured by Keyence Corp.) and conducting calculation using an associated software.

An interval between adjacent two of the point-like pressure-sensitive adhesives in the pressure-sensitive adhesive product of the present invention is not particularly limited. The intervals may be different in every interval or may be the same in every interval. The intervals between adjacent two of the point-like pressure-sensitive adhesives is preferably the same from the standpoint that the characteristics such as re-peelability and adhesiveness are stably obtained. In other words, it is preferred in the pressure-sensitive adhesive product of the present invention that the point-like pressure-sensitive adhesives are present on the substrate at equal intervals from the standpoint that the characteristics such as re-peelability and adhesiveness are stably obtained.

An interval (distance) between adjacent point-like pressure-sensitive adhesives in the pressure-sensitive adhesive product of the present invention is not particularly limited, and it is preferably 0.5 mm or more and less than 4.0 mm, more preferably 0.7 mm or more and less than 3.7 mm, still more preferably from 1.0 mm or more and less than 3.5 mm, and particularly preferably from 1.0 mm or more and less than 3.0 mm. When the interval between the adjacent point-like pressure-sensitive adhesives is 0.5 mm or more, the point-like pressure-sensitive adhesives do not attach to each other when transferring those, and glue cutting property becomes good, which is thus preferred. On the other hand, when the interval between the adjacent point-like pressure-sensitive adhesives is less than 4.0 mm, sufficient adhesiveness to an adherend can be easily obtained, which is thus preferred. Of those ranges, particularly when the interval between the adjacent point-like pressure-sensitive adhesives is 1.0 mm or more and less than 3.0 mm, the adherend can be further stably fixed. In particular, the pressure-sensitive adhesive product having such an interval can be preferably used in an application where re-peeling is possible, but stable fixation is strongly required.

The above-mentioned interval (distance) between the adjacent point-like pressure-sensitive adhesives is an interval between a center of one point-like pressure-sensitive adhesive and a center of the other point-like pressure-sensitive adhesive. For example, in the pressure-sensitive adhesive product 1 of FIG. 3, the interval means an interval between a center 121 of a certain point-like pressure-sensitive adhesive 12 and a center 121 of adjacent another point-like pressure-sensitive adhesive 12, which corresponds to an interval B.

The pressure-sensitive adhesive force of the pressure-sensitive adhesive product of the present invention is not particularly limited. The pressure-sensitive adhesive force is preferably from 0.1 N/25 mm or more and less than 2.5 N/25 mm, more preferably 0.3 N/25 mm or more and less than 2.3 N/25 mm, still more preferably 0.4 N/25 mm or more and less than 2.0 N/25 mm, and particularly preferably 0.4 N/25 mm or more and less than 1.7 N/25 mm. When the pressure-sensitive adhesive force is 0.1 N/25 mm or more, sufficient adhesiveness to an adherend can be easily obtained, which is thus preferred. When the pressure-sensitive adhesive force is less than 2.5 N/25 mm, good re-peelability can be obtained easily, which is thus preferred.

The pressure-sensitive adhesive force means a pressure-sensitive adhesive force on a face of a substrate on which two or more point-like pressure-sensitive adhesives are present, and is specifically obtained as follows. A polyethylene terephthalate film (PET film) is adhered to a “face on which two or more point-like pressure-sensitive adhesives are present” of a pressure-sensitive adhesive product, thereby obtaining a test piece. A substrate is removed from the test piece, the test piece is pressure-bonded to SUS plate (stainless plate) under pressure of a 2 kg roller driven to run once thereon, and the resulting assembly is allowed to stand in an environment of 23° C. for 30 minutes. After allowing the assembly to stand, the test piece is peeled from the SUS plate using a tensile tester under the conditions of peel angle: 180° and peel rate: 300 mm/min. Peel strength (adhesive strength) at the peeling is defined as the pressure-sensitive adhesive force (N/20 mm).

Incidentally, the test piece has a structure where two or more point-like pressure-sensitive adhesives are present on one face of the polyethylene terephthalate film. In other words, the point-like pressure-sensitive adhesives of the pressure-sensitive adhesive product are transferred to the test piece.

A peel time in a constant-load peel test described below using the pressure-sensitive adhesive product of the present invention is not particularly limited. The peel time is preferably from 20 to 90 minutes, and more preferably from 25 to 75 minutes. When the peel time is 20 minutes or more, good winding property when forming a wound product can be obtained, and occurrence of weaving in the form of a wound product can be effectively inhibited, which is thus preferred. Furthermore, sufficient adhesiveness to an adherend can be easily obtained, which is preferred. When the peel time is 90 minutes or less, good re-peelability can be obtained, which is thus preferred.

Constant-load peel test: A polyethylene terephthalate film (PET film) is attached to a “face on which two or more point-like pressure-sensitive adhesives are present” of a pressure-sensitive adhesive product, thereby obtaining a test piece. The test piece is attached to one face of a polycarbonate plate such that the point-like pressure-sensitive adhesives are brought into contact with the polycarbonate plate. The resulting laminate is pressure-bonded under pressure of 2 kg roller driven to run once thereon, and is then allowed to stand for 16 hours. After allowing the laminate to stand for 16 hours, 50 gf load is applied to an end in a length direction of the test piece in a direction vertical to the face of the polycarbonate plate, thereby starting the peeling of the test piece. The elapsed time when the test piece has been peeled 100 mm in a length direction is measured, and is defined as the peel time.

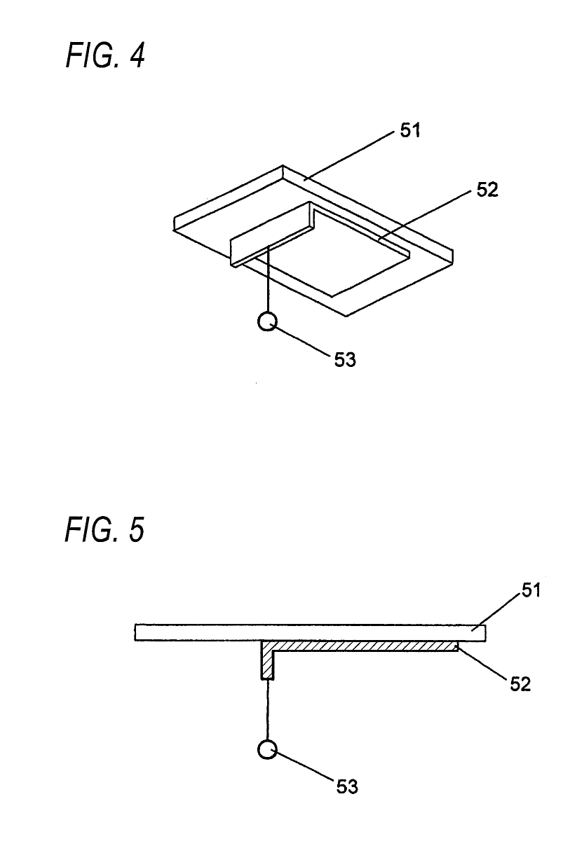

Explanatory views of the constant-load peel test are shown in FIGS. 4 and 5. The test piece has a structure in which the point-like pressure-sensitive adhesives are present on one face of the polyethylene terephthalate film. In other words, the point-like pressure-sensitive adhesives of the pressure-sensitive adhesive product are transferred to the test piece.

### (Point-Like Pressure-Sensitive Adhesive)

A size of a point-like pressure-sensitive adhesive in the pressure-sensitive adhesive product of the present invention is not particularly limited. The sizes of the point-like pressure-sensitive adhesives may be the same or different in every point-like pressure-sensitive adhesive. It is preferred that the sizes of the point-like pressure-sensitive adhesives are substantially the same from the standpoint of stably obtaining the characteristics such as re-peelability and adhesiveness.

The size of the point-like pressure-sensitive adhesive is not particularly limited, and it is preferably from 0.3 to 5.0 mm, more preferably from 0.3 to 4.0 mm, and still more preferably from 0.5 to 3.5 mm. When the size of the point-like pressure-sensitive adhesive is 0.3 mm or more, sufficient adhesiveness to an adherend can be easily obtained, which is thus preferred. On the other hand, when the size of the point-like pressure-sensitive adhesive is 5.0 mm or less, good re-peelability can be obtained easily, which is thus preferred. Additionally, the size of 5.0 mm or less is preferred also from the standpoint that protrusion of paste is reduced. In the present description, the term “protrusion of paste” means a phenomenon that when a pressure-sensitive adhesive product is attached to an adherend to transfer point-like pressure-sensitive adhesives to the adherend, a point-like pressure-sensitive adhesive contacted with only a part of a shape of the adherend and transferred thereto protrudes from the shape of the adherend.

The size of the point-like pressure-sensitive adhesive is obtained by measuring an area of the point-like pressure-sensitive adhesive, obtaining a circle having the same area as that area measured, and obtaining a diameter of the circle. In the pressure-sensitive adhesive product of FIG. 3, the point-like pressure-sensitive adhesive 12 has a circular shape. Therefore, a size A of the point-like pressure-sensitive adhesive 12 corresponds to the diameter thereof.

A thickness (height) of a point-like pressure-sensitive adhesive is not particularly limited. The thicknesses of the point-like pressure-sensitive adhesives may the same or different in every point-like pressure-sensitive adhesive. It is preferred that the thicknesses of the point-like pressure-sensitive adhesives are substantially the same from the standpoint of stably obtaining the characteristics such as re-peelability and adhesiveness.

The thickness of the point-like pressure-sensitive adhesive is not particularly limited, and it is preferably from 5 to 80 μm, and more preferably from 10 to 50 μm. When the thickness of the point-like pressure-sensitive adhesive is 5 μm or more, sufficient adhesiveness to an adherend can be easily obtained, which is thus preferred. Additionally, the thickness of 5 μm or less is preferred from the standpoint of transferring of the point-like pressure-sensitive adhesive. On the other hand, when the thickness of the point-like pressure-sensitive adhesive is 80 μm or less, good re-peelability can be obtained easily, which is thus preferred.

The thickness of the point-like pressure-sensitive adhesive means a thickness of the largest portion in a height direction of the point-like pressure-sensitive adhesive. For example, the thickness of the point-like pressure-sensitive adhesive 12 in the pressure-sensitive adhesive product 1 of FIG. 2 corresponds to a height h.

A shape of a point-like pressure-sensitive adhesive is not particularly limited. Examples thereof include a circular shape (for example, true circular shape, elliptical shape, semicircular shape, semielliptical shape, ¼ circular shape, ¼ elliptical shape or fan-like shape), a polygonal shape (for example, triangular shape, guadrangular shape, pentagonal shape, square shape, rectangular shape, trapezoidal shape or rhombic shape), a boat shape, a linear shape, a star shape, a wedge shape, an arrow shape, a comb shape, a butterfly shape and an indefinite shape. The shape of the point-like pressure-sensitive adhesive 12 of the pressure-sensitive adhesive product 1 of FIG. 1 is a circular shape.

The shape of the point-like pressure-sensitive adhesive is preferably a circular shape from the standpoints of easy formation of the point-like pressure-sensitive adhesive, productivity of a pressure-sensitive adhesive product, and transferring property to a component.

The shape of the point-like pressure-sensitive adhesive of the pressure-sensitive adhesive product of the present invention is not particularly limited. The shapes of the point-like pressure-sensitive adhesives may be the same or different in every point-like pressure-sensitive adhesive. It is preferred that the shapes of all of the point-like pressure-sensitive adhesives are substantially the same from the standpoint of stably obtaining the characteristics such as re-peelablity and adhesiveness.

The shape of the point-like pressure-sensitive adhesive is a projection shape when a face having the point-like pressure-sensitive adhesives on a substrate is regarded as a projection plane, and is a shape seen from a side of a face having the point-like pressure-sensitive adhesives on the substrate.

The kind of the pressure-sensitive adhesive constituting the point-like pressure-sensitive adhesive is not particularly limited. Examples of the pressure-sensitive adhesive include acrylic pressure-sensitive adhesives, rubber pressure-sensitive adhesives, vinyl alkyl ether pressure-sensitive adhesives, silicone pressure-sensitive adhesives, polyester pressure-sensitive adhesives, polyether pressure-sensitive adhesives, polyamide pressure-sensitive adhesives, urethane pressure-sensitive adhesives, fluorine-containing pressure-sensitive adhesives, and epoxy pressure-sensitive adhesives. Those pressure-sensitive adhesives may be used alone or as mixtures of two or more thereof.

Of those pressure-sensitive adhesives, acrylic pressure-sensitive adhesive is preferred from the standpoints of pressure-sensitive adhesiveness, weather resistance and coatability.

An acrylic pressure-sensitive adhesive is a pressure-sensitive adhesive containing, as a base polymer, an acrylic polymer constituted of an acrylic monomer as an essential monomer component. In other words, the acrylic pressure-sensitive adhesive is a pressure-sensitive adhesive containing, as a base polymer, an acrylic polymer that is a polymer containing a structural unit derived from an acrylic monomer.

The content of the acrylic polymer in the acrylic pressure-sensitive adhesive (100% by weight) is not particularly limited. The content is preferably 60% by weight or more (for example, from 60 to 100% by weight), and more preferably 80% by weight or more (for example, from 80 to 100% by weight).

The pressure-sensitive adhesive may be a pressure-sensitive adhesive having any form. The pressure-sensitive adhesive may be, for example, an emulsion-type pressure-sensitive adhesive, a solvent-based (solution-based) pressure-sensitive adhesive, an active energy ray-curable pressure-sensitive adhesive, or a thermally-melting pressure-sensitive adhesive (hot-melt pressure-sensitive adhesive).

The acrylic pressure-sensitive adhesive varies depending on the formation method and is not particularly limited. For example, the acrylic pressure-sensitive adhesive is preferably formed by a pressure-sensitive adhesive composition (acrylic pressure-sensitive adhesive composition) containing an acrylic polymer as an essential component, or a pressure-sensitive adhesive composition (acrylic pressure-sensitive adhesive composition) containing, as an essential component, a mixture of monomers (sometimes referred to as a “monomer mixture”) constituting the acrylic polymer or its partial polymer. Although not particularly limited, examples of the former include so-called a solvent-based pressure-sensitive adhesive composition, and examples of the latter include so-called an active energy ray-curable pressure-sensitive adhesive composition.

The term “monomer mixture” means a mixture consisting of monomer components constituting a polymer. The term “partial polymer” means a composition in which at least one component in the constituent components of the monomer mixture is partially polymerized.

The acrylic monomer as the essential monomer component constituting the acrylic polymer preferably contains an alkyl(meth)acrylate having a linear or branched alkyl group. That is, the acrylic polymer is preferably a polymer constituted by employing an alkyl(meth)acrylate having a linear or branched alkyl group, as an essential monomer component. In other words, the acrylic polymer is preferably a polymer containing a structural unit derived from an alkyl(meth)acrylate having a linear or branched alkyl group. The monomer components constituting the acrylic polymer may contain a copolymerizable monomer such as a polar group-containing monomer or a polyfunctional monomer, described hereinafter. The term “(meth)acryl” used herein means “acryl and/or methacryl” (any one or both of “acryl” and “methacryl”). The acrylic monomer may be used alone or two or more thereof may be used in combination. Furthermore, the copolymerizable monomer may be used alone or two or more thereof may be used in combination.

Examples of the alkyl(meth)acrylate having a linear or branched alkyl group (hereinafter sometimes simply referred to as an “alkyl(meth)acrylate”) include alkyl(meth)acrylates having from 1 to 20 carbon atoms in the alkyl moiety, such as methyl (meth)acrylate, ethyl (meth)acrylate, propyl(meth)acrylate, isopropyl(meth)acrylate, n-butyl (meth)acrylate, isobutyl (meth)acrylate, s-butyl (meth)acrylate, t-butyl (meth)acrylate, pentyl(meth)acrylate, isopentyl(meth)acrylate, hexyl(meth)acrylate, heptyl(meth)acrylate, octyl(meth)acrylate, 2-ethylhexyl(meth)acrylate, isooctyl(meth)acrylate, nonyl(meth)acrylate, isononyl(meth)acrylate, decyl(meth)acrylate, isodecyl(meth)acrylate, undecyl(meth)acrylate, dodecyl(meth)acrylate, tridecyl(meth)acrylate, tetradecyl(meth)acrylate, pentadecyl(meth)acrylate, hexadecyl(meth)acrylate, heptadecyl(meth)acrylate, octadecyl(meth)acrylate, nonadecyl(meth)acrylate and eicosyl(meth)acrylate. The alkyl(meth)acrylates may be used alone or two or more thereof may be used in combination.

Of those alkyl(meth)acrylates, alkyl(meth)acrylates having from 1 to 14 carbon atoms in the alkyl moiety are preferred, and n-butyl acrylate (BA) and 2-ethylhexyl acrylate (2EHA) are more preferred.

The content of the alkyl(meth)acrylate in the total amount (100% by weight) of the monomer component(s) constituting the acrylic polymer is preferably 60% by weight or more, and more preferably 80% by weight or more, based on the total amount (100% by weight) of the monomer component(s) constituting the acrylic polymer.

Examples of the polar group-containing monomer include carboxyl group-containing monomers such as (meth)acrylic acid, itaconic acid, maleic acid, fumaric acid, crotonic acid, isocrotonic acid, and their acid anhydrides (for example, acid anhydride-containing monomers such as maleic anhydride and itaconic anhydride); hydroxyl group-containing monomers such as 2-hydroxyethyl (meth)acrylate, 3-hydroxypropyl(meth)acrylate, 4-hydroxybutyl (meth)acrylate, 6-hydroxyhexyl(meth)acrylate, vinyl alcohol and allyl alcohol; amide group-containing monomers such as (meth)acrylamide, N,N-dimethyl (meth)acrylamide, N-methylol(meth)acrylamide, N-methoxymethyl (meth)acrylamide, N-butoxymethyl (meth)acrylamide and N-hydroxyethyl (meth)acrylamide; amino group-containing monomers such as aminoethyl (meth)acrylate, dimethylaminoethyl (meth)acrylate and t-butylaminoethyl (meth)acrylate; epoxy group-containing monomers such as glycidyl(meth)acrylate and methylglycidyl(meth)acrylate; cyano group-containing monomers such as acrylonitrile and methacrylonitrile; hetero ring-containing vinyl monomers such as N-viyl-2-pyrrolidone, (meth)acryloylmorpholine, N-vinylpiperidone, N-vinylpiperadine, N-vinylpyrrole and N-vinylimidazole; sulfonic acid group-containing monomers such as sodium vinylsulfonate; phosphoric acid group-containing monomers such as 2-hydroxyethyl acryloylphosphate; imide group-containing monomers such as cyclohexylmaleimide and isopropylmaleimide; and isocyanate group-containing monomers such as 2-methacryloyloxyethyl isocyanate. The polar group-containing monomers may be used alone or two or more thereof may be used in combination.

Of those polar group-containing monomers, carboxyl group-containing monomers and hydroxyl group-containing monomers are preferred, and acrylic acid (AA), 2-hydroethyl acrylate (HEA) and 4-hydroxybutyl acrylate (4HBA) are more preferred.

The content of the polar group-containing monomer in the monomer components is not particularly limited. From the standpoints of adhesiveness and re-peelability, the content is preferably from 1 to 20% by weight, and more preferably from 1 to 15% by weight, based on the total amount (100% by weight) of the monomer components constituting the acrylic polymer.

Examples of the polyfunctional monomer include hexanediol di(meth)acrylate, butanediol di(meth)acrylate, (poly)ethylene glycol di(meth)acrylate, (poly)propylene glycol di(meth)acrylate, neopentyl glycol di(meth)acrylate, pentaerythritol di(meth)acrylate, pentaerythritol tri(meth)acrylate, dipentaerythritol hexa(meth)acrylate, trimethylolpropane tri(meth)acrylate, tetramethylolpropane tri(meth)acrylate, allyl(meth)acrylate, vinyl(meth)acrylate, divinylbenzene, epoxy acrylate, polyester acrylate and urethane acrylate. Those polyfunctional monomers may be used alone or two or more thereof may be used in combination.

The content of the polyfunctional monomer in the total amount (100% by weight) of monomer components constituting the acrylic polymer is not particularly limited. The content is preferably from 0.01 to 2% by weight, and more preferably from 0.02 to 1% by weight, based on the total amount (100% by weight) of the monomer components constituting the acrylic polymer.

Examples of the copolymerizable monomer include alkoxyalkyl esters of (meth)acrylic acid (alkoxyalkyl(meth)acrylates) such as 2-methoxyethyl (meth)acrylate, 2-ethoxyethyl (meth)acrylate, methoxytriethylene glycol(meth)acrylate, 3-methoxypropyl(meth)acrylate, 3-ethoxypropyl(meth)acrylate, 4-methoxybutyl (meth)acrylate and 4-ethoxybutyl (meth)acrylate; (meth)acrylates other than the above-described alkyl(meth)acrylates, alkoxyalkyl(meth)acrylates, polar group-containing monomers and polyfunctional monomers, for example, (meth)acrylates having an alicyclic hydrocarbon group such as cyclopentyl(meth)acrylate, cyclohexy(meth)acrylate or isobornyl(meth)acrylate, and (meth)acrylates having an aromatic hydrocarbon group such as phenyl(meth)acrylate, phenoxyethyl (meth)acrylate and benzyl (meth)acrylate; vinyl esters such as vinyl acetate and vinyl propionate; aromatic vinyl compounds such as styrene and vinyl toluene; olefins or dienes, such as ethylene, butadiene, isoprene and isobutylene; vinyl ethers such as vinyl alkyl ether; and vinyl chloride. Those copolymerizable monomers are sometimes referred to as “other copolymerizable monomers”.

Examples of a polymerization method of the acrylic polymer include a solution polymerization method, an emulsion polymerization method, a bulk polymerization method, and a polymerization method by active ray irradiation (active energy ray polymerization method). Of those polymerization methods, a solution polymerization method is preferred from the standpoint of workability and costs. In other words, the acrylic polymer is preferably obtained by polymerizing the monomer components by a solution polymerization method.

In conducting the solution polymerization, various ordinary solvents may be used. Examples of the solvents include organic solvents, for example, esters such as ethyl acetate and n-butyl acetate; aromatic hydrocarbons such as toluene and benzene; aliphatic hydrocarbons such as n-hexane and n-heptane; alicyclic hydrocarbons such as cyclohexane and methyl cyclohexane; and ketones such as methyl ethyl ketone and methyl isobutyl ketone. Those solvents may be used alone or two or more thereof may be used in combination.

In conducting the polymerization, polymerization initiators such as a photopolymerization initiator or a thermal polymerization initiator may be used. Those polymerization initiators may be used alone or two or more thereof may be used in combination.

In conducting the solution polymerization, a thermal polymerization initiator may be used. The thermal polymerization initiator is not particularly limited, and examples thereof include azo-type initiators, peroxide-type polymerization initiators (such as dibenzoyl peroxide and tert-butyl permaleate), and redox-type polymerization initiators. Of those initiators, the azo-type initiators disclosed in JP-A-2002-69411, which is herein incorporated by reference, are particularly preferred. These azo-type initiators are preferred for the reason that a decomposed product of the initiator is difficult to remain as a part that causes generation of a gas generated by heating (outgas) in the acrylic polymer. Examples of the azo-type initiator include 2,2′-azobisisobutyronitrile (hereinafter sometimes referred to as “AIBN”), 2,2′-azobis-2-methylbutyronitrile (hereinafter sometimes referred to as AMBN), dimethyl 2,2′-azobis(2-methylpropionate) and 4,4′-azobis-4-cyanovaleric acid. The amount of the thermal polymerization initiator used is not particularly limited, and may be in a range applicable as a polymerization initiator by which desired molecular weight and reactivity are obtained.

The acrylic pressure-sensitive adhesive may contain a crosslinking agent. In other words, the acrylic pressure-sensitive adhesive composition for forming the acrylic pressure-sensitive adhesive may contain a crosslinking agent. By using a crosslinking agent, the acrylic polymer as a base polymer is crosslinked, and gel fraction of the acrylic pressure-sensitive adhesive can be controlled.

The crosslinking agent is not particularly limited, and examples thereof include an isocyanate crosslinking agent, an epoxy crosslinking agent, a melamine crosslinking agent, a peroxide crosslinking agent, a urea crosslinking agent, a metal alkoxide crosslinking agent, a metal chelate crosslinking agent, a metal salt crosslinking agent, a carbodiimide crosslinking agent, an oxazoline crosslinking agent, an aziridine crosslinking agent and an amine crosslinking agent. Those crosslinking agents may be used alone or two or more thereof may be used in combination.

Examples of the isocyanate crosslinking agent (polyfunctional isocyanate compound) include lower aliphatic polyisocyanates such as 1,2-ethylene diisocyanate, 1,4-butylene diisocyanate and 1,6-hexamethylene diisocyanate; alicyclic polyisocyanates such as cyclopentylene diisocyanate, cyclohexylene diisocyanate, isophorone diisocyanate, hydrogenated tolylene diisocyanate and hydrogenated xylene diisocyanate; and aromatic polyisocyanates such as 2,4-tolylene diisocyanate, 2,6-tolylene diisocyanate, 4,4′-diphenylmethane diisocyanate and xylylene diisocyanate. The isocyanate crosslinking agent can use commercially available products such as trimethylolpropane/tolylene diisocyanate adduct (trade name: CORONATE L, manufactured by Nippon Polyurethane Industry Co., Ltd.), trimethylolpropane/hexamethylene diisocyanate adduct (trade name: CORONATE HL, manufactured by Nippon Polyurethane Industry Co., Ltd.), trimethylolpropane/xylylene diisocyanate adduct (trade name: TAKENATE 110N, manufactured by Mitsui Chemical, Inc.) and hexamethylene diisocyanate crosslinking agent (HDI crosslinking agent) (trade name: DURANATE, manufactured by Asahi Kasei Chemicals Corporation).

Examples of the epoxy crosslinking agent (polyfunctional epoxy compound) include N,N,N′N′-tetraglycidyl-m-xylenediamine, diglycidylaniline, 1,3-bis(N,N-diglycidylaminomethyl)cyclohexane, 1,6-hexanediol diglycidyl ether, neopentyl glycol diglycidyl ether, ethylene glycol diglycidyl ether, propylene glycol diglycidyl ether, polyethylene glycol diglycidyl ether, polypropylene glycol diglycidyl ether, sorbitol polyglycidyl ether, glycerol polyglycidyl ether, pentaerthrytol polyglycidyl ether, polyglycerol polyglycidyl ether, sorbitan polyglycidyl ether, trimethylolpropane polyglycidyl ether, diglycidyl adipate, diglycidyl o-phthalate, triglycidyl tris(2-hydroxyethyl)isocyanurate, resorcin diglycidyl ether, bisphenol-5-diglycidyl ether, and epoxy resins having at least two epoxy groups in the molecule. The epoxy crosslinking agent can further use commercially available products such as trade name: TETRAD C, manufactured by Mitsubishi Gas Chemical Company, Inc.

The content of the crosslinking agent is not particularly limited. The content thereof is preferably from 0.001 to 10 parts by weight, and more preferably from 0.01 to 5 parts by weight, per 100 parts by weight of the acrylic polymer.

If necessary, the acrylic pressure-sensitive adhesive may contain additives described hereinafter. Examples of the additives include crosslinking promoters, silane coupling agents, aging inhibitors, fillers, colorants (pigments, dyes and the like), UV absorbers, antioxidants, chain transfer agents, plasticizers, softeners and antistatic agents. Examples of the additives further include tackifying components such as acrylic oligomer, rosin derivative, polyterpene resin, petroleum resin and oil-soluble phenol. Those additives may be used alone or two or more thereof may be used in combination. In the case of using the acrylic pressure-sensitive adhesive in industrial processes such as optical use, display use (for example, liquid crystal display use, plasma display use, or organic EL display use), and mobile electronic device use, the pressure-sensitive adhesive product is required to have easy transferring property. Therefore, a colorant is preferably added to the pressure-sensitive adhesive product such that the point-like pressure-sensitive adhesive can be visually confirmed easily.

The gel fraction of the acrylic pressure-sensitive adhesive is not particularly limited. The gel fraction is preferably from 20 to 80% (% by weight), and more preferably from 30 to 70%, from the viewpoint that both adhesive characteristics and cohesive force are satisfied in high degree of balance, thereby obtaining good re-peelability.

The gel fraction (proportion of solvent-insoluble matter) is specifically a value calculated by, for example, the following “measurement method of gel fraction”.

(Measurement Method of Gel Fraction)

About 0.1 g of a pressure-sensitive adhesive is collected, and wrapped with a porous tetrafluoroethylene sheet having a mean pore size of 0.2 μm (trade name: NTF1122, manufactured by Nitto Denko Corporation), and tied up with a kite string. Its weight is measured as a weight before dipping. The weight before dipping is the total weight of the pressure-sensitive adhesive (the pressure-sensitive adhesive collected as above), the tetrafluoroethylene sheet and the kite string. Further, the total weight of the tetrafluoroethylene sheet and the kite string is separately measured and taken as a wrapping weight.

The pressure-sensitive adhesive wrapped with the tetrafluoroethylene sheet and then tied up with the kite string (this is referred to as a “sample”) is put in a 50 ml container filled with ethyl acetate, and kept therein at 23° C. for 7 days. Subsequently, the sample (treated with ethyl acetate) is taken out of the container, transferred into an aluminum cup, and dried in a drier at 130° C. for 2 hours to remove ethyl acetate. Its weight is measured as a weight after dipping.

The gel fraction is calculated by the following formula.

Gel fraction(% by weight)={(A−B)/(C−B)}×100

(In the formula, A is the weight after dipping, B is the wrapping weight and C is the weight before dipping.)

### (Substrate)

The substrate in the pressure-sensitive adhesive product of the present invention has a role to protect point-like pressure-sensitive adhesives, and further has a role as a support. At least one face of the substrate exerts easy peelability (property to easily peel) with respect to the point-like pressure-sensitive adhesives. In the pressure-sensitive adhesive product of the present invention, it is preferred that point-like pressure-sensitive adhesives are provided on a face of a substrate, the face exerting easy peelability with respect to the point-like pressure-sensitive adhesives.

The substrate is not particularly limited, and examples thereof include a substrate having a release-treated layer, a low-adhesive substrate comprising a fluorine polymer and a low-adhesive substrate comprising a non-polar polymer.

The substrate in the substrate having a release-treated layer is not particularly limited, and examples of such substrate include a resin substrate and a paper substrate. Examples of the resin substrate include a polyolefin substrate (polyethylene substrate, polypropylene substrate or the like), a polyester substrate (polyethylene terephthalate substrate, polyethylene naphthalate substrate, polybutylene terephthalate substrate or the like), a polyamide substrate (so-called “nylon” substrate) and a cellulose substrate (so-called “cellophane” substrate). Examples of the paper substrate include Japanese paper, western paper, fine quality paper, glassine paper, kraft paper, Clupak paper, crepe paper, clay-coated paper, top-coated paper and synthetic paper. The substrate may have a form of either of a single layer or a laminate.

Examples of the release treating agent (release agent) forming a release-treated layer of the substrate having the release-treated layer include a silicone release treating agent, a long chain alkyl release treating agent, a fluorine release treating agent and a molybdenum sulfide release treating agent. Those release treating agents may be used alone or two or more thereof may be used in combination.

Examples of the fluorine polymer in the low adhesive substrate comprising the fluorine polymer include polytetrafluoroethylene, polychlorotrifluoroethylene, polyvinyl fluoride, polyvinylidene fluoride, tetrafluoroethylene-hexafluoropropylene copolymer and chlorofluoroethylene-vinylidene fluoride copolymer.

Examples of the non-polar polymer in the low adhesive substrate comprising the non-polar polymer include olefin resins (for example, polyethylene and polypropylene).

The substrate is formed by the conventional methods. The thickness of the substrate is not particularly limited, but is preferably from 4 to 100 μm, and more preferably from 10 to 50 μm, from the standpoint of workability.

The peel strength of the substrate is not particularly limited, but is preferably from 0.01 to 0.30 N/50 mm, and more preferably from 0.02 to 0.20 N/50 mm. When the peel strength is 0.01 N/50 mm or more, the substrate can sufficiently hold the point-like pressure-sensitive adhesives, and can suppress unintended detachment and deviation of the point-like pressure-sensitive adhesives from the substrate, which is thus preferred. When the peel strength is 0.30 N/50 mm or less, good re-peelability can be obtained, which is thus preferred. The peel strength can be adjusted by selecting a material of the substrate or by selecting a release treating agent. The peel strength of the substrate means peel strength to a pressure-sensitive adhesive face provided by at least one point-like pressure-sensitive adhesive in the pressure-sensitive adhesive product.

The peel strength of the substrate is obtained as follows. A pressure-sensitive adhesive product (structure of substrate/point-like pressure-sensitive adhesive) is attached to a backing support (for example, PET film) to obtain a test piece (substrate/point-like pressure-sensitive adhesive/backing substrate). The substrate is peeled from the test piece under the conditions of peel angle: 180° and tensile rate: 300 mm/min by a tensile tester, and stress at that time is measured as “peel strength of substrate”.

In the case that the pressure-sensitive adhesive product of the present invention is a pressure-sensitive adhesive product in which point-like pressure-sensitive adhesives are protected by one substrate by winding the product in a roll form (single separator type pressure-sensitive adhesive product, hereinafter sometimes referred to as “pressure-sensitive adhesive product A”), the substrate is preferably a substrate in which one face is a heavy release face and the other face is a light release face. In the case that the pressure-sensitive adhesive product of the present invention is a pressure-sensitive adhesive product in which at least two point-like pressure-sensitive adhesives are present between two substrates and the point-like pressure-sensitive adhesives are protected by the two substrates (double separator type pressure-sensitive adhesive product, hereinafter sometimes referred to as “pressure-sensitive adhesive product B”), it is preferred that one substrate provides a heavy release face and the other substrate provides a light release face. In the description, the “heavy release face” of the substrate means a face having a larger peel strength, and the “light release face” of the substrate means a face having a smaller peel strength.

Formation of difference in peel strength as mentioned above can effectively inhibit “unintended adhesive removal (nori-hagare)” phenomenon and “unintended adhesive separation (naki-wakare)” phenomenon. The “unintended adhesive removal (nori-hagare)” phenomenon means a phenomenon that the point-like pressure-sensitive adhesive transfers to the back surface of the pressure-sensitive adhesive product when unwinding the pressure-sensitive adhesive product, or a phenomenon that when one substrate (particularly a substrate at light release face side) of the pressure-sensitive adhesive product B is peeled, a part of the point-like pressure-sensitive adhesive remains on the substrate peeled. The “unintended adhesive separation (naki-wakare)” phenomenon means a phenomenon that when unwinding the pressure-sensitive adhesive product A or when peeling one substrate of the pressure-sensitive adhesive product B, the substrate does not peel at a given interface at which the substrate should originally peel, and peels at an interface at which the substrate should be originally adhered to the point-like pressure-sensitive adhesive.

It is preferred in the pressure-sensitive adhesive product of the present invention that the peel strength at the heavy release face side of the substrate is from 0.05 to 0.30 N/50 mm (preferably from 0.07 to 0.20 N/50 mm) and the peel strength at the light release face side of the substrate is from 0.01 to 0.15 N/50 mm (preferably from 0.02 to 0.10 N/50 mm), from the standpoint of effective inhibition of “unintended adhesive removal (nori-hagare)” phenomenon and “unintended adhesive separation (naki-wakare)” phenomenon. The peel strength at the heavy release face side is larger than the peel strength at the light release face side.

### (Pressure-Sensitive Adhesive Product)

The pressure-sensitive adhesive product of the present invention is produced by providing at least two point-like pressure-sensitive adhesive compositions on the substrate using the above-described pressure-sensitive adhesive composition, and then curing these point-like pressure-sensitive adhesive compositions, thereby providing at least two point-like pressure-sensitive adhesives on at least one face of the substrate. For example, the pressure-sensitive adhesive product shown in FIGS. 1 to 3 is produced by providing at least two point-like pressure-sensitive adhesive compositions on a substrate 11b using a pressure-sensitive adhesive composition, curing the point-like pressure-sensitive adhesive compositions to form point-like pressure-sensitive adhesives 12, and providing a substrate 11a on the point-like pressure-sensitive adhesives 12 so as to protect the point-like pressure-sensitive adhesives 12.

In providing at least two point-like pressure-sensitive adhesive compositions on the substrate using a pressure-sensitive adhesive composition, the conventional coating method or printing method may be used. Examples of the coating method include methods using a coater such as gravure roll coater, reverse roll coater, kiss roll coater, dip roll coater, bar coater, knife coater, spray coater, comma coater or direct coater. Examples of the printing method include gravure printing method, flexo printing method, offset printing method, emboss printing method and screen printing method. According to those methods, area ratio of the pressure-sensitive adhesive product, size and shape of the point-like pressure-sensitive adhesive, thickness of the point-like pressure-sensitive adhesive, distance between the point-like pressure-sensitive adhesives, distribution form of the point-like pressure-sensitive adhesives, and the like can be easily adjusted.

The pressure-sensitive adhesive product of the present invention has the point-like pressure-sensitive adhesives on the substrate, and therefore exerts a pressure-sensitive adhesiveness to an adherend. Furthermore, the point-like pressure-sensitive adhesives are present on the substrate and the area ratio falls within the given range. Therefore, the pressure-sensitive adhesive product has an excellent re-peelability.

The pressure-sensitive adhesive product of the present invention has, not a layer-form pressure-sensitive adhesive, but point-like pressure-sensitive adhesives on the substrate. Therefore, when the pressure-sensitive adhesive product is adhered to an adherend, air can be inhibited from being confined between the pressure-sensitive adhesive product and the adherend, whereby lifting and peeling of the pressure-sensitive adhesive product or wrinkles in the pressure-sensitive adhesive product due to air bubbles can be inhibited.

In the pressure-sensitive adhesive product of the present invention, adhesive force of the point-like pressure-sensitive adhesive to the substrate is weak, and the point-like pressure-sensitive adhesive has a pressure-sensitive adhesiveness. Therefore, the pressure-sensitive adhesive product has an excellent transfer property of the point-like pressure-sensitive adhesive. As a result, when an adherend is placed on the pressure-sensitive adhesive product of the present invention and the adherend is pressed, the point-like pressure-sensitive adhesive easily peels from the substrate and the point-like pressure-sensitive adhesive transfers to the adherend.

In particular, from the standpoint of effectively obtaining the characteristics described above, it is preferred that the pressure-sensitive adhesive product of the present invention includes at least two circular point-like pressure-sensitive adhesives provided regularly on the substrate, the area ratio is from 10 to 60%, and an interval between the adjacent point-like pressure-sensitive adhesives is 0.5 mm or more and less than 4.0 mm.

The pressure-sensitive adhesive product of the present invention has the above-described characteristics, and is therefore preferably used in various fixation applications, particularly temporary fixation applications (above all, temporary fixation applications in industrial processes). For example, (i) in combining components (members) to each other in production processes of a product, the pressure-sensitive adhesive product of the present invention is attached to one component to transfer the point-like pressure-sensitive adhesives to the component, thereby obtaining a point-like pressure-sensitive adhesive-attached component, and by utilizing the point-like pressure-sensitive adhesives of this point-like pressure-sensitive adhesive-attached component, the pressure-sensitive adhesive product can be used in temporal fixation before final strong fixation.

(ii) In incorporating a component into a chassis in the production process of a product, the pressure-sensitive adhesive product of the present invention is attached to the component to transfer the point-like pressure-sensitive adhesives to the component, thereby preparing a point-like pressure-sensitive adhesive-attached component, and by utilizing the point-like pressure-sensitive adhesives of this point-like pressure-sensitive adhesive-attached component, the pressure-sensitive adhesive product can be used in temporal fixation of the component to the chassis.

(iii) In a case where a poor component is found in the inspection step that is one of production processes of a product, reutilization of such a poor component may be tried. The pressure-sensitive adhesive product of the present invention can be used to fix the component so as to easily re-utilize the component.

(iv) In conveying a component in the production processes of a product, the pressure-sensitive adhesive product of the present invention is attached to the component to transfer the point-like pressure-sensitive adhesives to the component, thereby obtaining a point-like pressure-sensitive adhesive-attached component, and by utilizing the point-like pressure-sensitive adhesives of this point-like pressure-sensitive adhesive-attached component, the component may be fixed to a belt conveyer or the like that is used in conveying so that the component can be conveyed. Incidentally, temporal fixation applications are not limited to (i) to (iv) above.

More specifically, the pressure-sensitive adhesive product of the present invention can be preferably used in a method including a transfer step of attaching the pressure-sensitive adhesive product of the present invention to a first component to transfer point-like pressure-sensitive adhesives to a first component, an attaching step of attaching the first component having the point-like pressure-sensitive adhesives transferred thereto to a second component to form a laminate, an inspection step of inspecting the laminate, and a peel step of peeling at least one of the first component and the second component from the laminate judged as poor in the inspection step. For example, in a case where, after attaching an electronic component to a chassis and conducting wiring, the wiring is judged as being poor in the inspection step, the electronic component, the chassis and the like can be reutilized.

### (Fixation Method of Components)

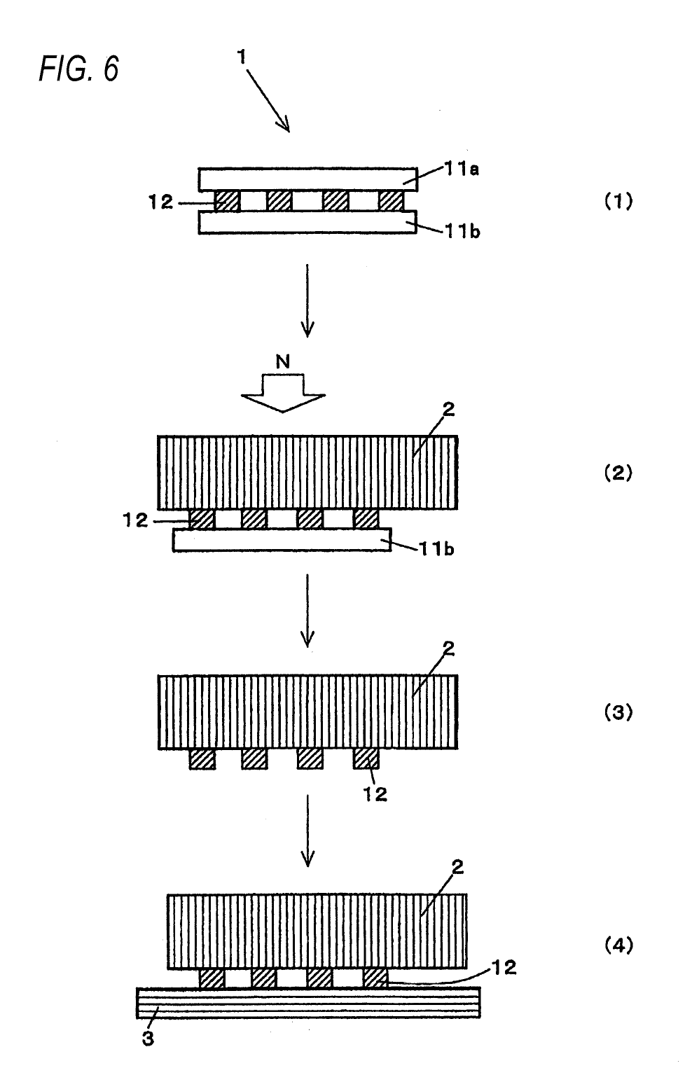

The fixation method of component according to the present invention is a method of transferring the point-like pressure-sensitive adhesives in the pressure-sensitive adhesive product (the pressure-sensitive adhesive product of the present invention) to a component, and then fixing the component to the adherend (for example, a chassis or another component). The fixation method of the components according to the present invention is a method of transferring the point-like pressure-sensitive adhesives in the pressure-sensitive adhesive product to a first component and then fixing the first component to a second component. Specific embodiment of the fixation method of components according to the present invention is described below with reference to FIG. 6. FIG. 6 is one embodiment of the fixation method using the pressure-sensitive adhesive product of the present invention. The fixation method of components according to the present invention is not limited to the embodiment shown in FIG. 6.

The fixing method shown in FIG. 6 uses a double separator type pressure-sensitive adhesive product 1 and includes the following steps (1) to (4).

Step (1) is a step of peeling one substrate (substrate 11a) from a pressure-sensitive adhesive product 1 and exposing point-like pressure-sensitive adhesives 12. It is preferred from the standpoint of easily exposing the point-like pressure-sensitive adhesives 12 that a peel face of the substrate 11a is a light release face and a peel face of a substrate 11b is a heavy release face.

Step (2) is a step of positioning a first component 2 on the exposed point-like pressure-sensitive adhesives 12 to transfer the point-like pressure-sensitive adhesives 12 to the first component 2. In the step (2) of the present embodiment, the first component 2 is pushed to the point-like pressure-sensitive adhesives 12, whereby the first component 2 applies force N to the point-like pressure-sensitive adhesives 12, and the point-like pressure-sensitive adhesives 12 transfers to the first component 2. In FIG. 6, the force N is applied from the first component 2 side, but the force N may be applied from the substrate 11b side, whereby the point-like pressure-sensitive adhesives 12 similarly transfer to the first component 2.

Step (3) is a step of peeling the substrate 11b from the structure obtained in the step (2). The first component 2 having the point-like pressure-sensitive adhesives (point-like pressure-sensitive adhesive-attached component) is obtained by the step (3).

Step (4) is a step of fixing the first component 2 having the point-like pressure-sensitive adhesives, which is obtained by the step (3), to a second component 3 through the point-like pressure-sensitive adhesives 12. Consequently, the first component 2 is fixed to the second component 3 through the point-like pressure-sensitive adhesives 12.

According to the fixation method of the present invention, the pressure-sensitive adhesive product described above is used, and therefore, a component can be easily fixed to a desired position. After the fixation method, the component may be strongly fixed by an adhesive having a higher adhesive force or other fixation means. Specifically, in this case, a component is temporarily fixed to an adherend by the above-described fixation method, and the temporarily fixed component is then formally fixed to the adherend.

### EXAMPLES

The present invention is described more specifically below with reference to the following Examples and Comparative Examples, but the present invention should not be limited by those.

### Examples and Comparative Examples

A solvent type acrylic pressure-sensitive adhesive composition was applied in a dot form to a 25 μm thick PET film having one face having been subjected to heavy release treatment with a silicone release agent (hereinafter sometimes referred to as a “heavy release treated PET film”) by gravure printing, drying was conducted by heating, and a point-like pressure-sensitive adhesives was formed on one face of the PET film. To protect the point-like pressure-sensitive adhesives, a 25 μm thick PET film having one face having been subjected to light release treatment with a silicone release agent (hereinafter sometimes referred to as a “light release treated PET film”) was attached thereto. The resulting laminate was wound in a roll form to obtain a pressure-sensitive adhesive product.

The printing mold used was a printing mold adjusted such that point-like pressure-sensitive adhesives could be regularly distributed and regularly circular point-like pressure-sensitive adhesives could be provided, and was adjusted such that a size of a point-like pressure-sensitive adhesive, a thickness of a point-like pressure-sensitive adhesive, an interval between point-like pressure-sensitive adhesives, and an area ratio, as shown in Table 1 could be obtained in every Example and Comparative Example.

In the pressure-sensitive adhesive products of Examples and Comparative Examples, circular point-like pressure-sensitive adhesives were regularly distributed on the substrate; the sizes, the thicknesses and the shapes of the circular point-like pressure-sensitive adhesives were unified; and intervals between adjacent point-like pressure-sensitive adhesives were unified.

### (Evaluation)

The following measurement and evaluation were made to Examples and Comparative Examples. The results obtained are shown in Table 1.

### (Measurement of Pressure-Sensitive Adhesive Force)

The light release treated PET film was peeled from the pressure-sensitive adhesive product. A 25 μm thick PET film (trade name: LUMIRROR S10, manufactured by Toray Industries, Inc.) was attached to a face of the pressure-sensitive adhesive product having the exposed point-like pressure-sensitive adhesives to obtain the pressure-sensitive adhesive product backed with the PET film. The pressure-sensitive adhesive product backed with the PET film was cut in a width of 25 mm to obtain a test piece (width: 25 mm, length: 100 mm).

The heavy release treated PET film was peeled from the test piece to expose the face having the point-like pressure-sensitive adhesives. The test piece was attached to SUS plate (stainless plate) and pressure-bonded thereto under the conditions of 2 kg roller driven to run once thereon. The resulting assembly was allowed to stand in an environment of 23° C. for 30 minutes. After allowing to stand, the test piece was peeled from the SUS plate under the conditions of peel angle: 180° and peel rate: 300 mm/min using a tensile tester (apparatus name: AUTOGRAPH, manufactured by Shimadzu Corporation) to measure peel strength (N/20 mm). The peel strength measured was taken as the pressure-sensitive adhesive force.

### (Measurement of Peel Time by Constant-Load Peel Test)

The light release treated PET film was peeled from the pressure-sensitive adhesive product. A PET film (trade name: LUMIRROR S10, manufactured by Toray Industries, Inc.) was attached to a face of the pressure-sensitive adhesive product having the exposed point-like pressure-sensitive adhesives to obtain the pressure-sensitive adhesive product backed with the PET film. The pressure-sensitive adhesive product backed with the PET film was cut in a width of 20 mm to obtain a test piece (width: 20 mm, length: 150 mm).

The heavy release treated PET film was peeled from the test piece to expose the face having the point-like pressure-sensitive adhesives. The face of the test piece having the exposed point-like pressure-sensitive adhesives was attached to one face of a polycarbonate plate (manufactured by Mitsubishi Gas Chemical Company, Inc.) such that the point-like pressure-sensitive adhesives were brought into contact with the polycarbonate plate, and pressure-bonded thereto under pressure of 2 kg roller driven to run once thereon. The resulting assembly was allowed to stand for 16 hours. After allowing to stand for 16 hours, 50 gf load was applied to an end in a length direction of the test piece in a vertical direction to the surface of the polycarbonate plate to initiate peeling of the test piece. Elapse time when the test piece had been peeled 100 mm in a length direction was measured and taken as the peel time.

### (Evaluation of Re-Peelability)

The light release treated PET film was peeled from the pressure-sensitive adhesive product. SUS plate was attached to a face of the pressure-sensitive adhesive product having the exposed point-like pressure-sensitive adhesives, and pressure-bonded thereto under condition of 2 kg roller driven to run once thereon to transfer the point-like pressure-sensitive adhesives. The resulting assembly was allowed to stand for 30 minutes. Thus, a test piece (test piece having at least one point-like pressure-sensitive adhesive on one face of the SUS plate) was obtained.

The heavy release treated PET film was peeled from the test piece to expose the face having the point-like pressure-sensitive adhesive. A pressure-sensitive adhesive tape (trade name: DANPRON S No. 3653, manufactured by Nitto Denko CS system Corporation) was brought into contact with the point-like pressure-sensitive adhesive of the exposed test piece, and then peeled therefrom.

As a result, a case where the point-like pressure-sensitive adhesive could be easily removed from the SUS plate was defined as “Good”, and a case where the point-like pressure-sensitive adhesive could not be removed even though repeating contact and peeling was defined as “Poor”.

TABLE 1

| | | | | | | | Comparative |
|---|---|---|---|---|---|---|---|
| | | Example 1 | Example 2 | Example 3 | Example 4 | Example 5 | Example 1 |
| Point-like | Size (mm) | 1 | 1 | 1 | 2 | 2 | 2 |
| pressure- | Thickness | 10 | 10 | 10 | 10 | 10 | 10 |
| sensitive | (μm) | | | | | | |
| adhesive | | | | | | | |

| | | | | | | |
|---|---|---|---|---|---|---|
| Interval between adjacent | 2.2 | 2.0 | 1.5 | 3.0 | 2.5 | 2.2 |
| point-like pressure- | | | | | | |
| sensitive adhesives (mm) | | | | | | |
| Area ratio (%) | 16 | 27 | 35 | 35 | 50 | 78 |
| Pressure-sensitive | 0.5 | 0.7 | 1.1 | 1.1 | 1.5 | 2.5 |
| adhesive force (N/25 mm) | | | | | | |
| Peel time by constant-load | — | — | 59 | 37 | — | — |
| heavy peel test (min) | | | | | | |
| Re-peelability | Good | Good | Good | Good | Good | Poor |

In the pressure-sensitive adhesive product of Example 3, peel strength of the heavy release face side was 0.110 N/50 mm, and on the other hand, peel strength of the light release face side was 0.053 N/50 mm.

While the invention has been described in detail and with reference to specific embodiments thereof, it will be apparent to one skilled in the art that various changes and modifications can be made therein without departing from the scope thereof.

This application is based on Japanese patent application No. 2012-043870 filed Feb. 29, 2012, the entire contents thereof being hereby incorporated by reference.

### DESCRIPTION OF REFERENCE NUMERALS

1 Pressure-sensitive adhesive product
   11a Substrate
   11b Substrate
   12 Point-like pressure-sensitive adhesive
      121 Center
A Size of point-like pressure-sensitive adhesive
B Interval (distance) between point-like pressure-sensitive adhesives
2 First component
3 Second component
N Force
51 Polycarbonate plate
52 Test piece
53 Weight

What is claimed is:

1. A pressure-sensitive adhesive product comprising a substrate and at least two point-like pressure-sensitive adhesives on the substrate, wherein an area ratio is from 10 to 60%,
the area ratio (%) being a proportion of an area occupied by said point-like pressure-sensitive adhesives per unit area of the substrate.

2. The pressure-sensitive adhesive product according to claim 1, wherein an interval between adjacent two of said point-like pressure-sensitive adhesives is 0.5 mm or more and less than 4.0 mm.

3. A fixation method of components, comprising transferring said point-like pressure-sensitive adhesives in the pressure-sensitive adhesive product according to claim 1 to a first component, and then fixing the first component to a second component.

4. The fixation method of components according to claim 3, wherein an interval between adjacent two of said point-like pressure-sensitive adhesives is 0.5 mm or more and less than 4.0 mm.
